(19) United States
(12) Patent Application Publication
(10) Pub. No.: US 2006/0115162 A1
(43) Pub. Date: Jun. 1, 2006

(54) Apparatus and method for processing image based on layers

(75) Inventors: Wonjun Hwang, Seoul (KR); Seokcheol Kee, Yongin-si (KR); Chanmin Park, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD, Suwon-si (KR)

(21) Appl. No.: 11/145,178

(22) Filed: Jun. 6, 2005

(30) Foreign Application Priority Data
Nov. 26, 2004 (KR) 10-2004-0098147

(51) Int. Cl. G06K 9/56; G06K 9/54

(52) U.S. Cl. 382/205; 382/302

(57) ABSTRACT

An apparatus and method for processing an image based on layers. The apparatus includes: an image divider dividing an image into E layers, each layer having at least one block, e being an positive integer at least equal to 2; and first through E-th layer basis matrix generators respectively generating first through E-th layer basis matrices using the divided image and outputting a set of the first through E-th layer basis matrices as a final basis matrix, wherein the e-th (1≦e≦E) layer basis matrix generator, with respect to each block included in the e-th layer, generates a block model using a kernel matrix obtained by local feature analysis, multiplies a zero mean matrix generated from the divided image by the result of transposing the block model, calculates a between-class scatter matrix and a within-class scatter matrix by linear discriminant analysis using the multiplied result, calculates a discriminant transformation matrix using the calculated between-class scatter matrix and the calculated within-class scatter matrix, multiplies the discriminant transformation matrix by the block model, outputs the multiplied result as a subbasis matrix, and outputs a set of subbasis matrices generated in all of the blocks included in the e-th layer as the e-th layer basis matrix.

### CROSS-REFERENCE TO RELATED APPLICATION

This application claims the benefit of Korean Patent Application No. 10-2004-0098147, filed on Nov. 26, 2004, in the Korean Intellectual Property Office, the disclosure of which is incorporated herein by reference.

### BACKGROUND OF THE INVENTION

1. Field of the Invention

The present invention relates to an apparatus and method for processing an image for facial recognition used in a biometrics, video surveillance, or multimedia retrieval system etc. as an essential technology, and more particularly, to an apparatus and method for processing an image based on layers.

2. Description of Related Art

Recently, a variety of methods for improving the performance of facial recognition have been suggested. One of the conventional methods, local feature analysis (LFA), has been introduced by P. S. Penev and J. J. Atick [“Local Feature Analysis: A General Statistical Theory for Object Representation,” Network: Communication in Neural Systems, Vol. 7, No. 3, pp. 477-500, 1996]. Sparsification used in reducing dimension of an image and a correlation of values obtained by LFA is performed to reduce a reconstruction error instead of improving discrimination of a facial model and thus, there is a limitation in the method. Another one of the conventional methods, linear discriminant analysis (LDA), has been introduced by P. N. Belhumeur, J. P. Hespanha, and D. J. Kriegman [“Eigenface vs. Fisherfaces: Recognition Using Class Specific Linear Projection,” IEEE Trans. PAMI, Vol. 19, No. 7, pp. 711-720, July 1997].

In order to solve the problem on a small sample size (SSS) caused by LFA and improve discrimination of a feature vector using LDA, another conventional method combining LFA and LDA has been introduced by Q. Yang, X. Ding, and Z. Chen [“Discriminant Local Feature Analysis of Facial Images,” IEEE Proc. ICIP, Spain, September, 2003]. In the conventional method, since selection of features is designed not to improve discrimination of a facial model but to minimize a reconstruction error, a structural problem still remains.

As another conventional method, local analysis, for example, component analysis shows only local characteristics, and thus, a local minimum problem may occur. This component analysis has been introduced by T. Kim, H. Kim, W. Hwang, S. Kee, and J. Kittler [“Independent Component Analysis in Facial Local Residue Space,” IEEE Proc., CVPR, Madison, USA, July 2003].

### BRIEF SUMMARY

An aspect of the present invention provides an apparatus for processing an image based on layers in which an image is divided into plurality of layers and basis matrices of the image are generated and used.

An aspect of the present invention also provides a method of processing an image based on layers by which an image is divided into plurality of layers and basis matrices of the image are generated and used.

According to an aspect of the present invention, there is provided an apparatus for processing an image based on layers, the apparatus including: an image divider dividing an image into E (where, E is a positive integer equal to or greater than 2) layers, each layer having at least one block; and first through E-th layer basis matrix generators respectively generating first through E-th layer basis matrices using the divided image and outputting a set of the first through E-th layer basis matrices as a final basis matrix, wherein the e-th (1≦e≦E) layer basis matrix generator, with respect to each block included in the e-th layer, generates a block model using a kernel matrix obtained by local feature analysis, multiplies a zero mean matrix generated from the divided image by the result of transposing the block model, calculates a between-class scatter matrix and a within-class scatter matrix by linear discriminant analysis using the multiplied result, calculates a discriminant transformation matrix using the calculated between-class scatter matrix and the calculated within-class scatter matrix, multiplies the discriminant transformation matrix by the block model, outputs the multiplied result as a subbasis matrix, and outputs a set of subbasis matrices generated in all of blocks included in the e-th layer as the e-th layer basis matrix, and the number of blocks of the layers is different from each other.

According to another aspect of the present invention, there is provided a method of processing an image based on layers, the method including: dividing an image into E (where, E is a positive integer equal to or greater than 2) layers, each layer having at least one block; and generating first through E-th layer basis matrices using the divided image and determining a set of the first through E-th layer basis matrices as a final basis matrix, wherein the generating of the e-th layer basis matrix comprises, with respect to each block included in the e-th layer, generating a block model using a kernel matrix obtained by local feature analysis, multiplying a zero mean matrix generated from the divided image by the result of transposing the block model, calculating a between-class scatter matrix and a within-class scatter matrix by linear discriminant analysis using the multiplied result, calculating a discriminant transformation matrix using the calculated between-class scatter matrix and the calculated within-class scatter matrix, multiplying the discriminant transformation matrix by the block model, outputting the multiplied result as a subbasis matrix, and outputting a set of the subbasis matrices generated in all of blocks included in the e-th layer as an e-th layer basis matrix, and the number of blocks of the layers is different from each other.

According to another aspect of the present invention, there is provided an image processing apparatus, including: an image divider dividing an the into E layers each having at least one block, E being a positive integer at least equal to 2; and first through E-th layer basis matrix generators respectively generating first through E-th layer basis matrices based on the divided image and outputting a set of the first through E-th layer basis matrices as a final basis matrix. An e-th layer basis matrix generator, for each block of an e-th layer, generates a block model using a kernel matrix obtained by local feature analysis, multiplies a zero mean matrix based on the divided image by a result of transposing the block model, calculates a between-class scatter matrix and a within-class scatter matrix by linear discriminant analysis based on the multiplied result, calculates a discriminant transformation matrix based on the between-class scatter matrix and the within-class scatter matrix, multiplies the discriminant transformation matrix by the block model, outputs the multiplied result as a subbasis matrix, and outputs a set of subbasis matrices generated in all of the blocks included in the e-th layer as the e-th layer basis matrix. e is a positive integer between 1 and E. A number of blocks differs for each layer.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a block diagram of an apparatus for processing an image based on layers according to an embodiment of the present invention;

FIG. 2 is a flowchart illustrating a method of processing an image based on layers performed in the apparatus shown in FIG. 1;

FIG. 3 illustrates a plurality of layers divided from an image;

FIGS. 4A through 4E illustrate sample images obtained using linear feature analysis (LFA);

FIG. 5 is a block diagram of an example of the e-th layer basis matrix generator shown in FIG. 1;

FIG. 6 is a block diagram of an example of the q-th subbasis matrix generator shown in FIG. 5;

FIG. 7 is a flowchart illustrating a method of processing an image based on layers according to an embodiment of the present invention performed in the q-th subbasis matrix generator shown in FIG. 6;

FIGS. 8A and 8B illustrate conventional basis images and basis images according to an embodiment of the present invention, respectively;

FIG. 9 is a flowchart illustrating a method of processing an image based on layers according to another embodiment of the present invention;

FIG. 10 is a block diagram of an example of the correlation calculator shown in FIG. 1;

FIGS. 11A through 11C illustrate images included in different types of databases; and

FIGS. 12A through 12C illustrate CMC curves for representing a difference in performance between a conventional apparatus and method for processing an image based on layers and the apparatus and method for processing an image based on layers according to an embodiment of the present invention according to types of databases.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

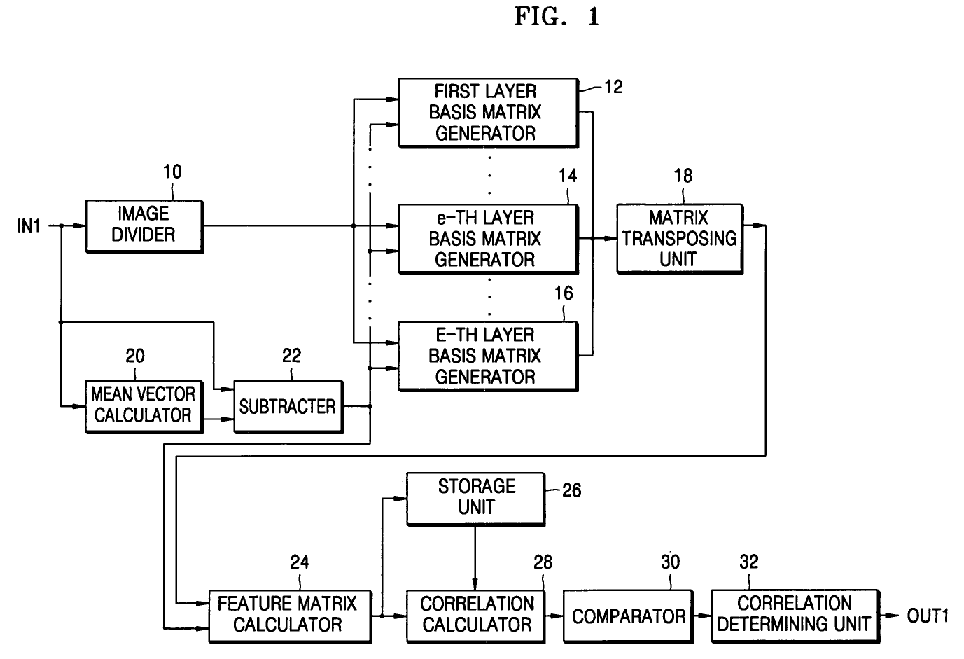

FIG. 1 is a block diagram of an apparatus for processing an image based on layers according to an embodiment of the present invention. The apparatus of FIG. 1 includes an image divider 10, first, . . . , e-th, . . . , and E-th layer basis matrix generators 12, . . . , 14, . . . , and 16, respectively, a matrix transposing unit 18, a mean vector calculator 20, a subtracter 22, a feature matrix calculator 24, a storage unit 26, a correlation calculator 28, a comparator 30, and a correlation determining unit 32. In the present embodiment, E is a positive integer equal to or greater than 2.

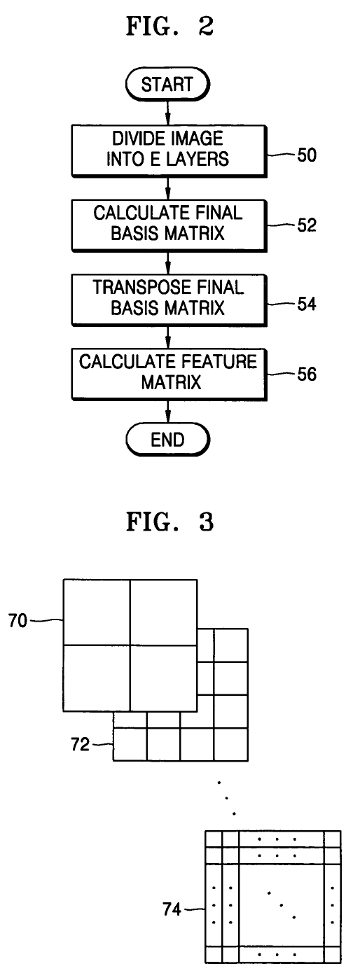

FIG. 2 is a flowchart illustrating a method of processing an image based on layers in the apparatus for processing an image based on layers shown in FIG. 1. The method of FIG. 2 includes dividing an image into a plurality of layers (operation 50), obtaining a final basis matrix using the divided image and transposing the final basis matrix (respective operations 52 and 54), and obtaining a feature matrix (operation 56).

In operation 50, the image divider 10 inputs an image through an input terminal IN1, divides the inputted image into E layers, and outputs the image divided into the E layers to the first through E-th layer basis matrix generators 12 to 16. In this case, each of the divided layers is composed of at least one block, and each layer has different numbers of blocks.

FIG. 3 illustrates a plurality of layers divided from an image. The plurality of layers include a first layer 70 having 4 blocks, a layer 72 having 16 blocks, and a last layer 74 having more than 16 blocks. Additional layers having more than 16 blocks but less than the number of blocks in the last layer 74 are contemplated.

For example, the image divider 10 can divide the image inputted through the input terminal IN1 into a plurality of layers 70, 72, and 74, for example, as shown in FIG. 3.

After operation 50, in operation 52, the first through E-th layer basis matrix generators 12 to 16 shown in FIG. 1 generate first through E-th layer basis matrices on first, second, . . . , and E-th layers using the divided image inputted from the image divider 10 and output a set of the first through E-th layer basis matrices as a final basis matrix to the matrix transposing unit 18. To this end, the e-th (1≦e≦E) layer basis matrix generator 14 generates an e-th layer basis matrix on an e-th layer as follows.

That is, the e-th layer basis matrix generator 14 generates a block model using a kernel matrix obtained by local feature analysis (LFA), multiplies a zero mean matrix (ZMM) generated from the divided image inputted from the image divider 10 by the result of transposing the block model, calculates a between-class scatter matrix and a within-class scatter matrix by linear discriminant analysis (LDA) using the multiplied result, calculates a discriminant transformation matrix using the calculated between-class scatter matrix and the calculated within-class scatter matrix, multiplies the discriminant transformation matrix by the block model, and outputs the multiplied result as a subbasis matrix. The e-th layer basis matrix generator 14 generates a subbasis matrix in each block included in the e-th layer and outputs a set of subbasis matrices generated in all of blocks included in the e-th layer as an e-th layer basis matrix.

Assuming that M learning images exist, ψᵢ is an N-dimensional vector obtained by a raster scan as an i-th learning image and 1≦i≦M, general LFA will be described below.

First, a mean vector m of M learning images is obtained using equation 1.

$$m = \frac{1}{M} {\sum }_{i = 1}^{M} {Ψ}_{i} \qquad ( 1 )$$

As shown in equation 2, a zero mean vector xᵢ with respect to the i-th learning image is obtained by subtracting the mean vector m from the i-th learning vector ψᵢ.
xᵢ=Ψᵢ−m (2)

The apparatus for processing an image based on layers shown in FIG. 1 also includes a mean vector calculator 20 and a subtracting unit 22 so as to obtain a zero mean matrix. Here, the mean vector calculator 20 calculates a mean vector of an image inputted through the input terminal IN1 as shown in equation 1, and outputs the calculated mean vector to the subtracting unit 22. In this case, the subtracting unit 22 subtracts the mean vector from the image inputted through the input terminal IN1 as shown in equation 2, and outputs the subtracted result as a zero mean vector. The subtracting unit 22 outputs a set of zero mean vectors as a zero mean matrix obtained using equation 3.
X=[x₁, . . . ,x_{M}] (3)

In this case, a covariance matrix S is obtained using equation 4.
S=X·X^{T} (4)
, where T is a transpose.

A series of kernels K may be defined using equation 5 with the use of eigen analysis, and the covariance matrix S expressed in equation 4 may be obtained using equation 6.
K=P·V·P^{T} (5)
S=P·D·P^{T} (6)
, where P is an eigen vector, D is an eigen value matrix, and V is obtained using equation 7.

$$V = diag ( \frac{{F}_{i}}{\sqrt{{λ}_{i}}} ) \qquad ( 7 )$$

, where diag( ) is a diagonal matrix, λᵢ is an i-th eigen vector of the covariance matrix S, Fᵢ is obtained using equation 8, and low-pass filtering is performed using Fᵢ.

$${F}_{i} = \frac{{λ}_{i}}{{λ}_{i} + {n}^{2}} \qquad ( 8 )$$

, where n is a specified number and may be 0.25, for example. As a result, an output kernel matrix K is obtained using equation 9.
K=[k₁, . . . ,k_{N}] (9)

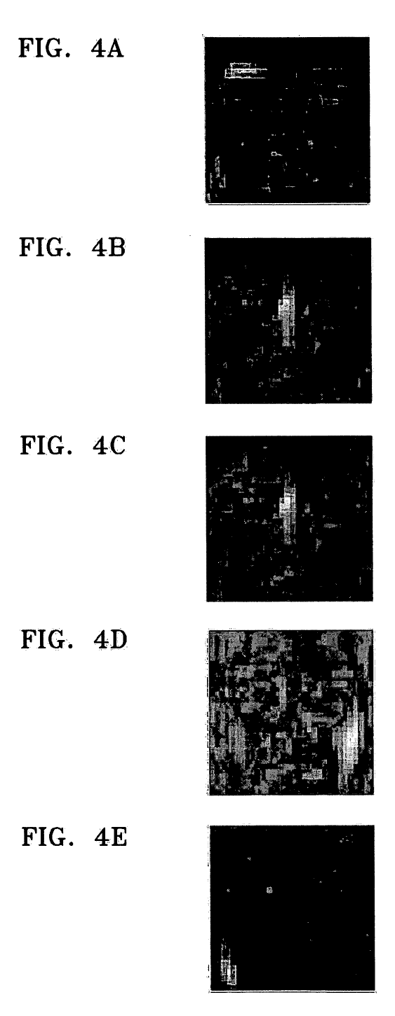

FIGS. 4A through 4E illustrate sample images obtained using LFA. FIG. 4A illustrates the local feature of eyebrows, FIG. 4B illustrates the local feature of noise, FIG. 4C illustrates the local feature of eyes around, FIG. 4D illustrates the local feature of cheek, and FIG. 4E illustrates the local feature of jaw.

Columns of the output kernel matrix K shown in equation 9 have spatially local features. As shown in FIGS. 4A through 4E, the columns of the output kernel matrix K are indexed to a spatial position and thus are topographic.

General LDA will now be schematically described below.

Traditional LDA is performed using a between-class scatter matrix S_{B} and a within-class scatter matrix S_{w} obtained using equations 10 and 11.

$$\begin{matrix}{S}_{B} {\sum }_{i = 1}^{c} {M}_{i} ( {m}_{i} - m ) {( {m}_{i} - m )}^{T} & ( 10 ) \\ {S}_{W} = {\sum }_{i = 1}^{c} {\sum }_{{Ψ}_{k} ∈ {c}_{i}} ( {Ψ}_{k} - {m}_{i} ) {( {Ψ}_{k} - {m}_{i} )}^{T} & ( 11 )\end{matrix}$$

, where Mᵢ is the number of image samples with respect to an i-th class, c is a total number of classes, mᵢ is a mean image of the i-th class having Mᵢ samples, and a projection vector W for satisfying a basic concept of LDA is obtained using equation 12.

$$W = {arg {max}_{}}_{W} \frac{\vert {W}^{T} {S}_{B} W \vert}{\vert {W}^{T} {S}_{W} W \vert} \qquad ( 12 )$$

, where arg max (or argmax) stands for the argument of the maximum. The term “arg max” is defined as the value of the given argument for which the value of the given expression attains its maximum value. The arg max is defined at the web site http://en.wikipedia.org/wiki/Arg max.

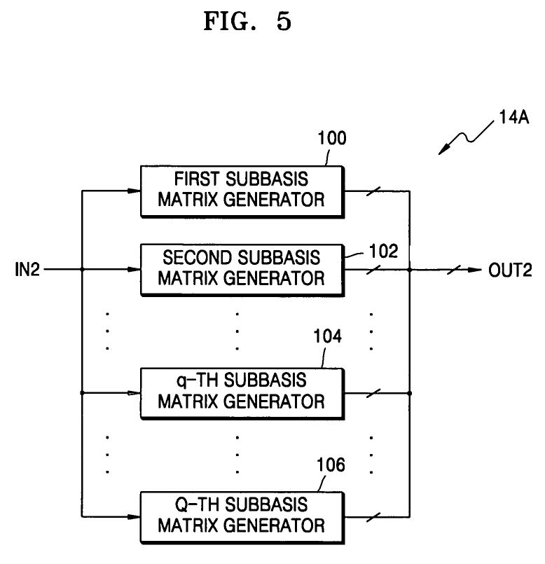

FIG. 5 is a block diagram of an example of the e-th layer basis matrix generator 14 shown in FIG. 1. The e-th layer basis matrix generator 14A includes first, second, . . . , q-th, . . . , and Q-th subbasis matrix generators 100, 102, . . . , 104, . . . , and 106, respectively. Here, Q is a total number of blocks included in an e-th layer, and 1≦q≦Q.

The first through Q-th subbasis matrix generators 100, 102, . . . , 104, . . . , and 106 shown in FIG. 5 respectively generate first through Q-th subbasis matrices using the divided image inputted through an input terminal IN2 and output a set of the first through Q-th subbasis matrix as an e-th layer basis matrix through an output terminal OUT2.

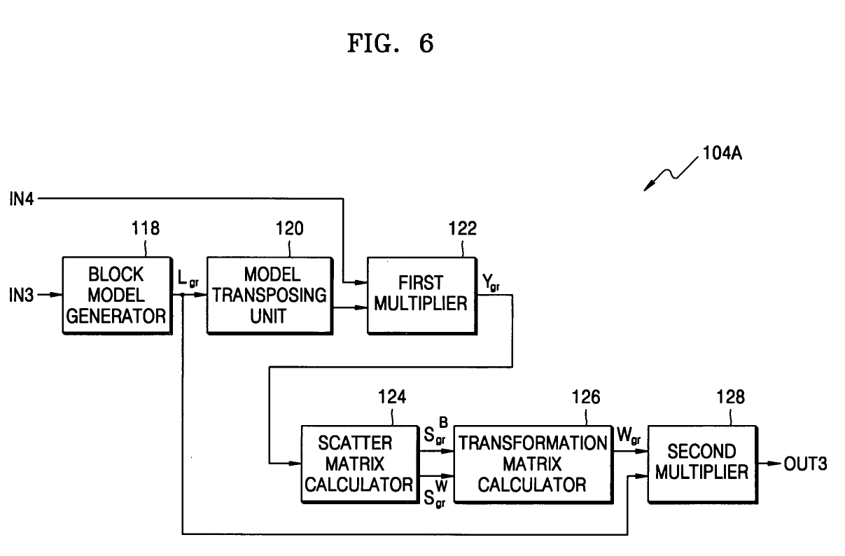

FIG. 6 is a block diagram of an example of the q-th subbasis matrix generator 104 shown in FIG. 5. The q-th subbasis matrix generator 104A includes a block model generator 118, a model transposing unit 120, a first multiplier 122, a scatter matrix calculator 124, a transformation matrix calculator 126, and a second multiplier 128.

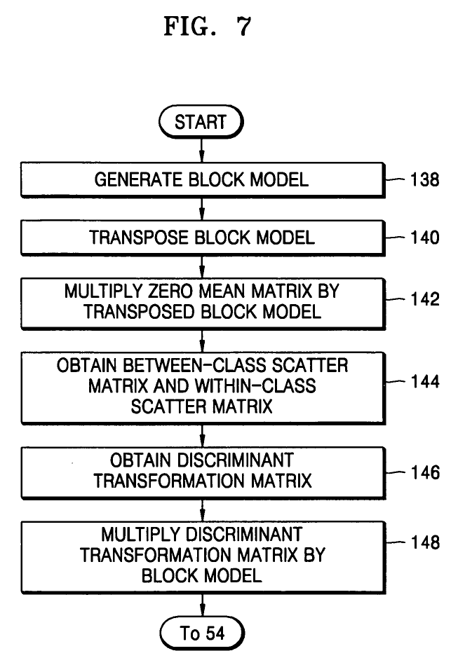

FIG. 7 is a flowchart illustrating a method of processing an image based on layers performed in the q-th subbasis matrix generator 104A shown in FIG. 6. The method of FIG. 7 includes generating a block model, transposing the block model and then multiplying the transposed result by a zero mean matrix (respective operations 138 through 142), obtaining a between-class scatter matrix and within-class scatter matrix, obtaining a discriminant transformation matrix (operations 144 and 146), and multiplying the discriminant transformation matrix by the block model (operation 148).

In operation 138, the block model generator 118 shown in FIG. 6 inputs the kernel matrix K obtained by LFA as described previously and expressed in equation 9, through an input terminal IN3, generates a block model using the inputted kernel matrix K, and outputs the generated block model L_{gr} to the model transposing unit 120 and the second multiplier 128, respectively. When a total number of blocks placed in a horizontal direction is G and a total number of blocks placed in a vertical direction is R in the e-th layer, the block model L_{gr} is a block model of a block placed in a sequence (g,r) in the e-th layer. Here, 1≦g≦G and 1≦r≦R.

After operation 138, in operation 140, the model transposing unit 120 transposes the block model generated by the block model generator 118 and outputs the transposed block model to the first multiplier 122.

After operation 140, in operation 142, the first multiplier 122 multiplies the zero mean matrix X inputted from the subtracting unit 22 through an input terminal IN4 by the transposed block model L_{gr}^{T} inputted from the model transposing unit 120 using equation 13, and outputs the multiplied result Y_{gr} to the scatter matrix calculator 124.
Y_{gr}=L_{gr}^{T}X (13)

After operation 142, in operation 144, the scatter matrix calculator 124 calculates a between-class scatter matrix S_{gr}^{B} and a within-class scatter matrix S_{gr}^{W} using the result Y_{gr} multiplied by the first multiplier 122 and the calculated between-class scatter matrix S_{gr}^{B} and within-class scatter matrix S_{gr}^{W} to the transformation matrix calculator 126. For example, the scatter matrix calculator 124 calculates the between-class scatter matrix S_{gr}^{B} and the within-class scatter matrix S_{gr}^{W} using the above-described equations 10 and 11, as shown in equations 14 and 15.

$$\begin{matrix}{S}_{g r}^{B} = {\sum }_{i = 1}^{c} {M}_{i} ( {m}_{g r}^{i} - {m}_{g r} ) {( {m}_{g r}^{i} - {m}_{g r} )}^{T} & ( 14 ) \\ {S}_{g r}^{W} = {\sum }_{i = 1}^{c} {\sum }_{{Y}_{g r} ∈ {c}_{i}} ( {Y}_{g r} - {m}_{g r}^{i} ) {( {Y}_{g r} - {m}_{g r}^{i} )}^{T} & ( 15 )\end{matrix}$$

, where Y_{gr}ⁱ is the result multiplied by the first multiplier 122 with respect to the i-th class, m_{gr}ⁱ is a mean vector of Y_{gr}ⁱ in the i-th class, m_{gr} is a total mean vector of results multiplied by the first multiplier 122, and cᵢ is the i-th class.

After operation 144, in operation 146, the transformation matrix calculator 126 calculates a discriminant transformation matrix W_{gr} using the between-class scatter matrix S_{gr}^{B} and within-class scatter matrix S_{gr}^{W} inputted from the scatter matrix calculator 124 and outputs the calculated transformation matrix W_{gr} to the second multiplier 128. For example, the transformation matrix calculator 126 calculates the discriminant transformation matrix W_{gr} using the above-described equation 12, as shown in equation 16.

$${W}_{g r} = {arg max}_{{W}_{g r}} \frac{\vert {W}_{g r}^{T} {S}_{g r}^{B} {W}_{g r} \vert}{\vert {W}_{g r}^{T} {S}_{g r}^{W} {W}_{g r} \vert} \qquad ( 16 )$$

After operation 146, in operation 148, the second multiplier 128 multiplies the discriminant transformation matrix W_{gr} generated by the transformation matrix calculator 126 by the block model L_{gr} generated by the block model generator 118 and outputs the multiplied result as a q-th subbasis matrix through an output terminal OUT3.

For example, assuming that the image divider 10 divides the image into the two layers 70 and 72 shown in FIG. 3, the apparatus for processing an image based on layers according to the present invention will now be described below.

The block model generator 118 shown in FIG. 6 generates block models with respect to the first layer 70 as shown in equation 17, and generates block models with respect to the second layer 72 as shown in equation 18. Here, in order to avoid confusion, for an explanatory convenience, the block models with respect to the first layer 70 are marked by L_{gr}, the block models with respect to the second layer 72 are marked by I_{gr}, the discriminant transformation matrix with respect to the first layer 70 is marked by W_{gr}, and the discriminant transformation matrix with respect to the second layer 72 is marked by w_{gr}.

$$\begin{matrix}{L}_{11} = \{ K ( u , v ) \vert 1 \leq u \leq \frac{w}{2} , 1 \leq v \leq \frac{h}{2} \} \\ ⋮ \\ {L}_{22} = \{ K ( u , v ) \vert ( \frac{w}{2} + 1 ) \leq u \leq w , ( \frac{h}{2} + 1 ) \leq v \leq h \} & ( 17 ) \\ {1}_{11} = \{ K ( u , v ) \vert 1 \leq u \leq \frac{w}{4} , 1 \leq v \leq \frac{h}{4} \} \\ ⋮ \\ {1}_{44} = \{ K ( u , v ) \vert ( \frac{3 w}{4} + 1 ) \leq u \leq w , ( \frac{3 h}{4} + 1 ) \leq v \leq h \} & ( 18 )\end{matrix}$$

, where u,v is a spatial position in each layer 70 or 72, w and h is the width and height of each layer 70 or 72, and K(u,v) is K_{u+v×w} and a column of the above-described kernel matrix K.

Each block model expressed in equation 17 has N/4 local kernels, and each block model expressed in equation 18 has N/16 local kernels.

In this case, the first layer basis matrix generator 12 shown in FIG. 1 includes first through fourth subbasis matrix generators 100 to 106 shown in FIG. 5. The first through fourth subbasis matrix generators 100 to 106 inputs the first layer 70 shown in FIG. 3 from the image divider 10 through an input terminal IN2, generates each of first, second, and third, and fourth subbasis matrices V₁₁, V₁₂, V₂₁, and V₂₂, and outputs a set of the first, second, third, and fourth subbasis matrices V₁₁, V₁₂, V₂₁, and V₂₂ as a first layer basis matrix V, as shown in equation 19.
V=[V₁₁,V₁₂,V₂₁,V₂₂] (19)
, where the first, second, third, and fourth subbasis matrices V₁₁, V₁₂, V₂₁, and V₂₂ with respect to the first layer 70 are obtained using equation 20.
V₁₁=L₁₁W₁₁
V₁₂=L₁₂W₁₂
V₂₁=L₂₁W₂₁
V₂₂=L₂₂W₂₂ (20)

Similarly, the second layer basis matrix generator 16 shown in FIG. 1 includes first through 16-th subbasis matrix generators 100 to 106 shown in FIG. 5. The first through 16-th subbasis matrix generators 100 to 106 inputs the second layer 72 shown in FIG. 3 from the image divider 10 through the input terminal IN2, generates each of first through 16-th subbasis matrices V₁₁ to V₄₄, and outputs a set of the first through 16-th subbasis matrices V₁₁ to V₄₄ as a second layer basis matrix v, as shown in equation 21.
v=[v₁₁,v₁₂, . . . ,v₄₄] (21)
, where the first through 16-th subbasis matrices V₁₁ to V₄₄ with respect to the second layer 72 are obtained using equation 22.

$${v}_{11} = {1}_{11} {w}_{11} \\ {v}_{12} = {1}_{12} {w}_{12} \\ ⋮ \\ {v}_{44} = {1}_{44} {w}_{44} \qquad ( 22 )$$

As a result, a final basis vector W of a set of first and second layer basis matrices V and v outputted from the first and second layer basis matrix generators 12 and 16 shown in FIG. 1 is obtained using equation 23.
W=[V,v] (23)

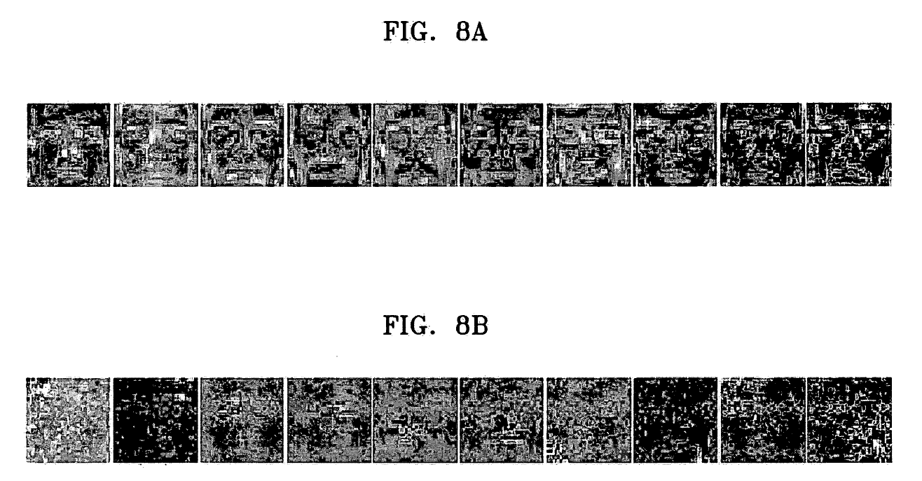

FIGS. 8A and 8B illustrate conventional basis images and basis images according to an embodiment of the present invention, respectively. FIG. 8A illustrates conventional basis images created when using principal component analysis (PCA) and LDA together (hereinafter, referred to as PCLDA), and FIG. 8B illustrates exemplary basis images created by the apparatus and method for processing an image based on layers according to the present invention. The basis images from left to right of FIG. 8B respectively relate to block models I₁₁, I₁₄, I₂₂, I₂₃, I₃₂, I₃₃, I₄₁, I₄₄, L₁₁, and L₂₂.

According to an embodiment of the present invention, the apparatus for processing an image is implemented by only the image divider of FIG. 1 and the first through E-th layer basis matrix generators 12 to 16 and can only generate a final basis matrix.

According to another embodiment of the present invention, the apparatus for processing an image based on layers may further include the mean vector calculator 20 and the subtracter 22 and may further generate a zero mean matrix from an inputted image.

According to another embodiment of the present invention, the apparatus for processing an image based on layers according to an embodiment of the present invention may further include the matrix transposing unit 18 and the feature matrix calculator 24 and may further generate a feature vector from a final basis vector as will be described below.

After operation 52, in operation 54, the matrix transposing unit 18 transposes the final basis matrix generated by the first through E-th layer basis matrix generators 12, . . . , 14, . . . , and 16 and outputs the transposed final basis matrix to the feature matrix calculator 24. After operation 54, in operation 56, the feature matrix calculator 24 multiplies a zero mean matrix X inputted from the subtracter 22 by the result transposed by the matrix transposing unit 18, as shown in equation 24 and outputs the multiplied result as a feature matrix.
fᵢ=W_{f}^{T}X (24)
, where fᵢ is a feature matrix with respect to an i-th class, and W_{f} is a final basis matrix.

If the image is divided into the two layers 70 and 72 shown in FIG. 3, the feature matrix has feature vectors having the same number as equation 25, a feature vector with respect to the first layer 70 is obtained using equation 26, and a feature vector with respect to the second layer 72 is obtained using equation 27.
(2×2)·k₁+(4×4)·k₂ (25)
f_{gr}¹=W_{gr}^{T}(L_{gr}^{T}(Ψ−m))=(L_{gr}W_{gr})^{T}(Ψ−m)=V_{gr}^{T}(Ψ−m) (26)
, where f_{gr}¹ is a feature vector with respect to the first layer 70, and Ψ is an image inputted through an input terminal IN1.
f_{gr}²=w_{gr}^{T}(l_{gr}^{T}(Ψ−m))=(l_{gr}w_{gr})^{T}(Ψ−m)=v_{gr}^{T}(Ψ−m) (27)
, where f_{gr}² is a feature vector with respect to the second layer 72.

The number of feature vectors shown in FIG. 8B is always smaller than the number of feature vectors shown in FIG. 8A.

As described above, a procedure for creating a final basis matrix or obtaining a feature matrix using the generated final basis matrix is referred to as a learning procedure.

According to another embodiment of the present invention, the apparatus for processing an image based on layers according to the present invention may further include the storage unit 26, the correlation calculator 28, the comparator 30, and the correlation determining unit 32 and may further recognize a correlation between two images.

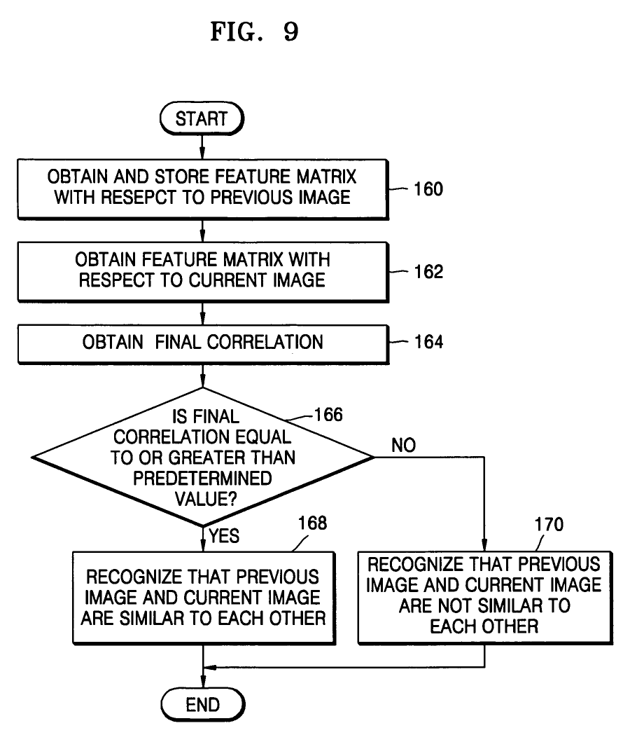

FIG. 9 is a flowchart illustrating a method of processing an image based on layers according to another embodiment of the present invention. The method of FIG. 9 includes obtaining a feature matrix with respect to a previous image and a feature matrix with respect to a current image (respective operations 160 and 162), obtaining a final correlation (operation 164), and determining a correlation according to the final correlation by determining whether the final correlation is equal to or greater than a specified value, recognizing that the previous image and current image are similar when the final correlation is equal to or greater than the specified value, and recognizing that a previous image and a current image are not similar to each other when the final correlation is not equal to or greater than the specified value (respective operations 166 to 170). Here, the previous image is an image that has been previously inputted into the apparatus for processing an image based on layers shown in FIG. 1 through an input terminal IN1, and the current image is an image that has been currently inputted into the apparatus for processing an image based on layers shown in FIG. 1 through the input terminal IN1.

In operation 160, the feature matrix calculator 24 calculates feature matrices with respect to previous images as described previously, and the storage unit 26 stores the feature matrices calculated by the feature matrix calculator 24 with respect to the previous images.

After operation 160, in operation 162, the feature matrix calculator 24 calculates feature matrices with respect to current images as described previously, and outputs feature matrices with respect to the calculated current images to the correlation calculator 28.

After operation 162, in operation 164, the correlation calculator 28 calculates a final correlation between the feature matrices outputted from the feature matrix calculator 24 with respect to the current images and the feature matrices read out from the storage unit 26 with respect to the previous images and outputs the calculated final correlation to the comparator 30.

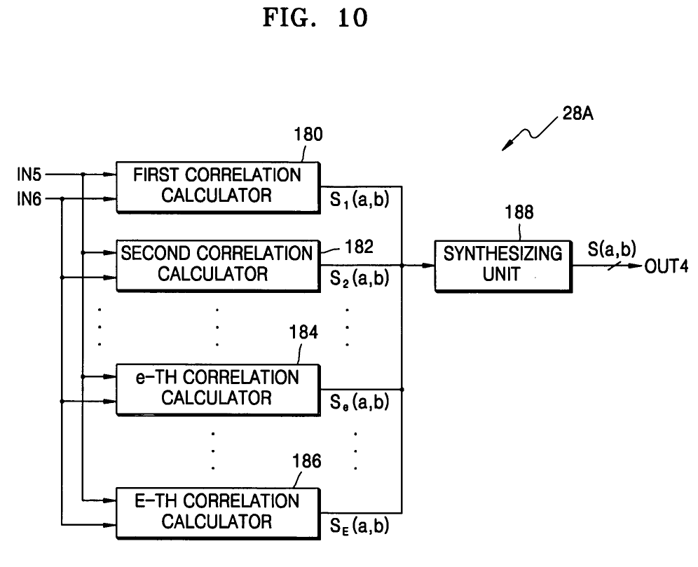

FIG. 10 is a block diagram of an example of the correlation calculator 28 shown in FIG. 1. The correlation calculator 28A includes first, second, . . . , e-th, . . . , and E-th correlation calculators 180, 182, . . . , 184, . . . , and 186, respectively, and a synthesizing unit 188.

The first through E-th correlation calculators 180 to 186 shown in FIG. 10 calculate first through E-th correlations between current images and previous images using the feature matrices inputted from the feature matrix calculator 24 and the feature matrices read out from the storage unit 26, and output the first through E-th correlations to the synthesizing unit 188. To this end, the first through E-th correlation calculators 180 to 186 input feature matrices of current images from the feature matrix calculator 24 through an input terminal IN5, input feature matrices of previous images from the storage unit 26 through an input terminal IN6, compare the inputted feature matrices with one another, and respectively obtain correlations therebetween. For example, the e-th correlation calculator 184 calculates an e-th correlation between a previous image and a current image with respect to an e-th layer using equation 28.

$${S}_{e} ( a , b ) = {\sum }_{r = 1}^{R} {\sum }_{g = 1}^{G} {W}_{g r} Z = {\sum }_{r = 1}^{R} {\sum }_{g = 1}^{G} {W}_{g r} ( \frac{{( {f}_{g r}^{e} )}^{a} \cdot {( {f}_{g r}^{e} )}^{b}}{‖ {( {f}_{g r}^{e} )}^{a} ‖ \cdot ‖ {( {f}_{g r}^{e} )}^{a} ‖} ) \qquad ( 28 )$$

, where ∥ ∥ is norm, Sₑ(a,b) is an e-th correlation between a previous image a and a current image b with respect to an e-th layer, and W_{gr} is a discriminant transformation matrix and is obtained using equation 29.

$${\sum }_{r = 1}^{R} {\sum }_{g = 1}^{G} {W}_{gr} = 1 \qquad ( 29 )$$

In equation 28, (f_{gr}^{e})^{a} is a feature vector of a block placed at a g-th position in a horizontal direction and at a r-th position in a vertical direction on an e-th layer of an image a and the result of multiplying V_{gr}^{T} and a zero mean vector. Here, V_{gr}^{T} is the result of transposing the result in which a block model of a block placed at a position (g,r) on the e-th layer is multiplied by a discriminant transformation matrix. Similarly, (f_{gr}^{e})^{b} is a feature vector of a block placed at a g-th position in a horizontal direction and at a r-th position in a vertical direction on the e-th layer of an image b. When E=2, (f_{gr}¹)^{a}[or, (f_{gr}¹)^{b}] with respect to a first layer of each of images a and b is obtained using equation 26, and (f_{gr}²)^{a}[or, (f_{gr}²)^{b}] with respect to a second layer of each of the images a and b is obtained using equation 27. In this case, the feature matrix calculated by the feature matrix calculator 24 is composed of GR feature vectors.

In addition, Z of equation 28 as a normalized correlation is a value, its ranging from ‘+1’ to ‘−1’, produced from an angle of Cosine by the two vector [(f_{gr}^{e})^{a} and (f_{gr}^{e})^{b}]. As Z is closer to ‘+1’, cos(0°)=1, the two images a and b with respect to the e-th layer becomes more similar to each other, and as Z is closer to ‘−1’, cos(180°)=−1, the two images a and b with respect to the e-th layer becomes less similar to each other.

The synthesizing unit 188 synthesizes first through E-th correlations [S₁(a,b), S₂(a,b), . . . , Sₑ(a,b), . . . and S_{E}(a,b)] respectively calculated by the first through E-th correlation calculators 180 to 186, and outputs the synthesized result as a final correlation [S(a,b)] to the comparator 30 through an output terminal OUT4.

After operation 164, in operation 166, the comparator 30 compares the final correlation calculated by the correlation calculator 28 with a specified value and outputs the compared result to the correlation determining unit 32. That is, the comparator 30 determines whether the final correlation calculated by the correlation calculator 28 is equal to or greater than the specified value or not.

If it is recognized through the compared result that the final correlation between the two images is equal to or greater than the specified value, in operation 168, the correlation determining unit 32 determines that there is a correlation between the previous image and the current image. That is, the correlation determining unit 32 recognizes that the previous image and the current image are similar to each other.

However, if it is recognized through the compared result that the final correlation between the two images is smaller than the specified value, in operation 170, the correlation determining unit 32 determines that there is no correlation between the previous image and the current image. That is, the correlation determining unit 32 recognized that the previous image and the current image are not similar to each other.

As described above, a procedure for recognizing a correlation between two images using a feature matrix is referred to as a recognition procedure.

When the apparatus and method for processing an image based on layers according to the above-described embodiments of the present invention is used for facial recognition, a facial image may be detected from the entire input image including entire face, the detected facial image may be normalized, the normalized facial image may be pre-processed, and the pre-processed facial image may be inputted through an input terminal IN1 of the apparatus for processing an image based on layers shown in FIG. 1. In this way, a procedure for detecting, normalizing, and pre-processing a facial image is referred to as a pain procedure.

The performance of the apparatus and method for processing an image based on layers according to the above-described embodiments of the present invention that can be used for facial recognition will now be described below with reference to the attached drawings.

The performance of the apparatus and method for processing an image based on layers according to the above-described embodiments of the present invention with respect to three different subsets, that is, “light subset”, “pose subset”, and “XM2VTS database” can be evaluated. Here, “light subset” and “pose subset” are databases generated by pose illumination expression (PIE) developed in Carnegie Mellon University and are introduced by T. Sim, S. Baker, and M. Bsat [“The CMU Pose Illumination, and Expression (PIE) Database,” International Conference on Automatic Face and Gesture Recognition, May 2002, pp. 53-58”]. In addition, “XM2VTS database” is introduced by K. Messer, J. Matas, J. Kittler, and K. Jonsson [“XM2VTSDB: The Extended M2VTS Database,” Audio and Video-based Biometric Person Authentication, March 1999, pp. 72-77”].

Specifically, “light subset” has 1,496 images with respect to the overall face having neutral illumination. “Pose subset” has 1,020 images having neutral expression under neutral illumination, and a pose change is limited to ±22.5°. “XM2VTS database” has 2,360 front facial images and changes illumination, expression, and time elapse etc. diversely.

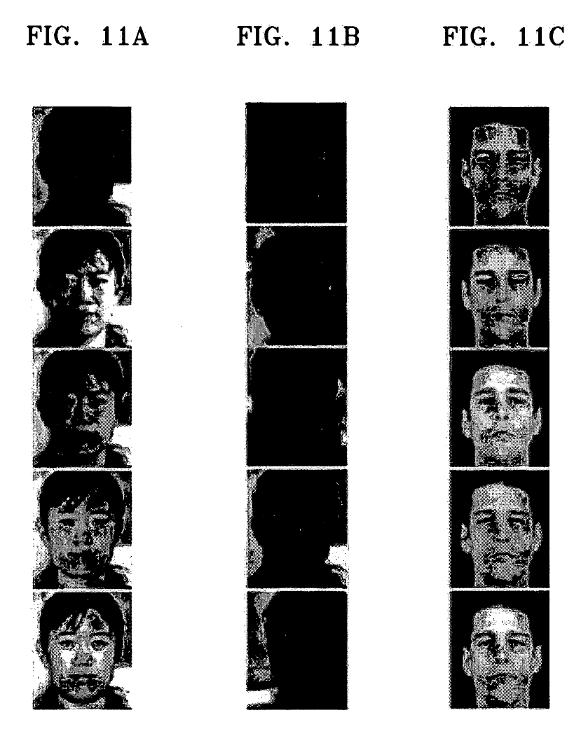

FIGS. 11A through 11C illustrate images included in different types of databases. FIG. 11A illustrate images included in a database “light subset”, FIG. 11B illustrate images included in a database “pose subset”, and FIG. 11C illustrate images included in a database “XM2VTS”.

All of images included in the databases are normalized to manual eye positions and adjusted to have the size of 32×32 pixels and backgrounds of the images are hidden, thereby obtaining the images shown in FIGS. 11A through 11C.

In this case, in order to obtain proper subspaces, 34 individuals are randomly selected from each of “light subset” and “pose subset” as a learning set. The other 34 subjects from each of “light subset” and “pose subset” are used for a test set, and “XM2VTS database” is used only for a test set. In this case, rank order statistics indicated by a graph like a cumulative match characteristic (CMC) curve, are used for a criterion for evaluating the performance of facial recognition.

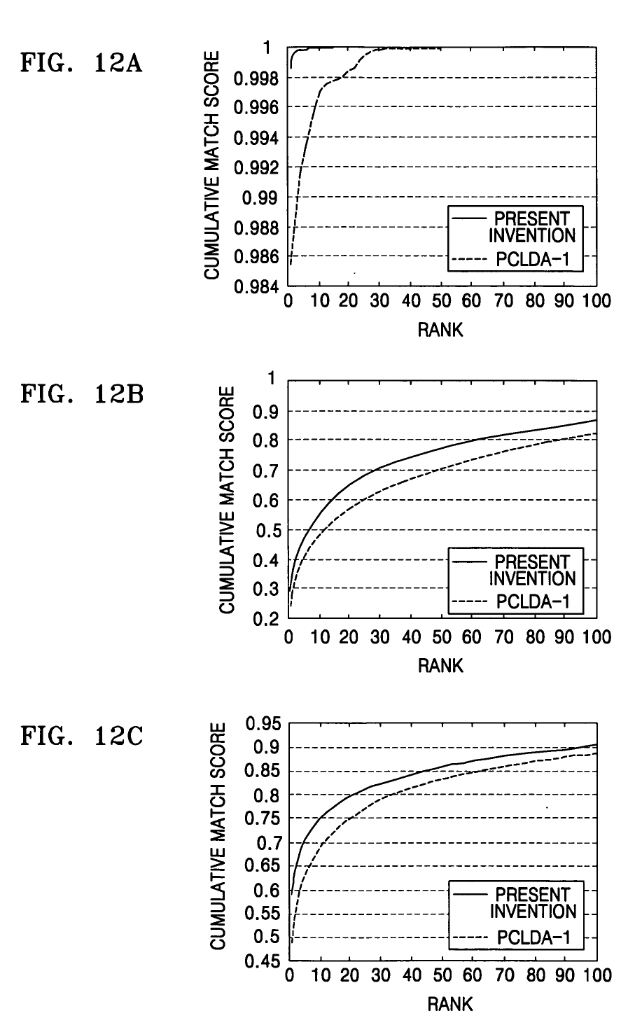

FIGS. 12A through 12C illustrate CMC curves for representing a difference in performance between a conventional apparatus and method for processing an image and the apparatus and method for processing an image based on layers according to an embodiment of the present invention according to types of databases. In each curve, a horizontal axis represents rank, and a vertical axis represents cumulative match score. FIG. 12A is a CMC curve with respect to “light subset”, FIG. 12B is a CMC curve with respect to “pose subset”, and FIG. 12C is a CMC curve with respect to “XM2VTS database”.

As shown in FIGS. 12A through 12C, the apparatus and method for processing an image based on layers according to an embodiment of the present invention show higher performance than the conventional apparatus and method in all of databases.

Table 1 shows two PCLDAs, that is, PCLDA-1 and PCLDA-2 and the entire recognition rate of the apparatus and method for processing an image based on layers according to the present invention.

TABLE 1

| | Learned Change | | Unlearned Change |
|---|---|---|---|
| Classification | Light Subset | Pose Subset | XM2VTS Database |
| PCLDA-1 | 36.61% | 17.47% | 47.90% |
| PCLDA-2 | 98.54% | 24.97% | 48.92% |
| Present Invention | 99.86% | 29.73% | 59.00% |

PCLDA-2 as well as PCLDA-1 has 33 number of features but the present invention has 660 (33×4+33×16) number of features. PCLDA-1 is excessively adjusted with respect to a learned change in a PIE database and there is a large difference in performance between PCLDA-1 and PCLDA-2 in a database “light subset”. This difference is not shown in a “XM2VTS database”. That is, while traditional PCLDA is easily overfitted by a learned change and shows a bad performance with respect to a unlearned change, the present invention always shows a good result in all of test sets and in particular, an increase in performance in “XM2VTS database” is worthy of close attention.

As described previously, in the apparatus and method for processing an image based on layers according to the above-described embodiments of the present invention, an image is divided into a plurality of layers, and linear discriminant analysis (LDA) is used in each block so as to determine which block among blocks included in each of the divided layers is important for facial recognition, instead of sparsification. That is, in the above-described embodiments of the present invention, local feature analysis (LFA) is adopted so as to express a facial image every a plurality of (local) blocks using block models and LDA is adopted so as to improve the discrimination of each block model. A block of each divided layer, that is, flocks of local feature can express own local feature and holistic facial information simultaneously. Thus, in the above-described embodiments of the present invention, since the flocks of local feature are used, a problem on a small sample size (SSS) can be easily solved, and since a basis matrix is generated using LDA, important information for recognition (not for expression) can be extracted. Further, many feature vectors can be extracted from different layers with respect to one facial image at separate viewpoints. In addition, two different feature spaces extracted from different ranges with respect to the same character can be made, and for example, a first layer for dividing an image can be used for low-frequency analysis, and a second layer can be used for high-frequency analysis.

In the apparatus and method for processing an image based on layers according to above-described embodiments of the present invention, without the use of a special sparsification scheme like in LFA, an image is divided into a plurality of layers and basis matrices are generated so that a correlation of LFA can be reduced and several feature vectors can be obtained every layers and blocks without causing an SSS problem. Since a final basis matrix is generated using LDA, feature matrices having high discrimination can be generated, and an image, in particular, a facial image can be better recognized using the feature matrices having high discrimination. A stable recognition performance even with respect to characteristics that are not generated in a learning procedure for generating basis matrices can be provided, and in particular, when comparing a conventional PCLDA, a facial model having a sufficient dimension occurred when the number of feature vectors increases in a limited learning database can be expressed, overfitting even with respect to a change that is not generated in the learning procedure can be coped with, and a more improved facial recognition performance can be provided. In other words, performance degradation caused by an unlearned change can be prevented, and due to adoption of holistic analysis, since an image is divided into layers and processed, unlike conventional PCLDA that may be affected when the overall face is recognized due to a spatial local change, local information as well as holistic information can be analyzed in a facial model having a remarkable local block feature, that is, the effect of a holistic facial image can be considered simultaneously with the emphasis of a local block so that a probability for being local minimum can be reduced and a robust facial recognition performance can be provided.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An apparatus for processing an image based on layers, the apparatus comprising:
an image divider dividing the image into E layers, each layer having at least one block, E being a positive integer at least equal to 2; and
first through E-th layer basis matrix generators respectively generating first through E-th layer basis matrices using the divided image and outputting a set of the first through E-th layer basis matrices as a final basis matrix,
wherein the e-th (1≦e≦E) layer basis matrix generator, with respect to each block included in the e-th layer, generates a block model using a kernel matrix obtained by local feature analysis, multiplies a zero mean matrix generated from the divided image by a result of transposing the block model, calculates a between-class scatter matrix and a within-class scatter matrix by linear discriminant analysis using the multiplied result, calculates a discriminant transformation matrix using the calculated between-class scatter matrix and the calculated within-class scatter matrix, multiplies the discriminant transformation matrix by the block model, outputs the multiplied result as a subbasis matrix, and outputs a set of subbasis matrices generated in all of the blocks included in the e-th layer as the e-th layer basis matrix, and
wherein a number of blocks of each of the layers differs.

2. The apparatus of claim 1, wherein the e-th basis matrix generator includes first through Q-th subbasis matrix generators respectively generating first through Q-th subbasis matrices and outputting a set of the first through Q-th subbasis matrices as the e-th layer basis matrix, Q being a total number of blocks included in the e-th layer, and
wherein the q-th (1≦q≦Q) subbasis matrix generator includes:
a block model generator generating the block model using the kernel matrix;
a model transposing unit transposing the block model;
a first multiplier multiplying the zero mean matrix and the transposed block model;
a scatter matrix calculator calculating the between-class scatter matrix and the within-class scatter matrix using the result of multiplied by the first multiplier;
a transformation matrix calculator calculating the discriminant transformation matrix using the between-class scatter matrix and the within-class scatter matrix; and
a second multiplier multiplying the discriminant transformation matrix by the block model and outputting the multiplied result as the q-th subbasis matrix.

3. The apparatus of claim 2, further comprising:
a mean vector calculator calculating a mean vector of the image; and
a subtracting unit subtracting the mean vector from the image and outputting a set of zero mean vectors of the result of subtracting as the zero mean vector.

4. The apparatus of claim 2, wherein the scatter matrix calculator calculates the between-class scatter matrix and the within-class scatter matrix respectively using the following equations:
$${S}_{gr}^{B} = {\sum }_{i = 1}^{c} {M}_{i} ( {m}_{gr}^{i} - {m}_{gr} ) {( {m}_{gr}^{i} - {m}_{gr} )}^{T} ; and {S}_{gr}^{W} = {\sum }_{i = 1}^{c} {\sum }_{{Y}_{gr} ∈ {c}_{i}} ( {Y}_{gr} - {m}_{gr}^{i} ) {( {Y}_{gr} - {m}_{gr}^{i} )}^{T} ,$$
where S_{gr}^{B} is the between-class scatter matrix, S_{gr}^{W} is the within-class scatter matrix, Mᵢ is the number of image samples with respect to an i-th class, c is a total number of classes, Y^{gr} is the result multiplied by the first multiplier, Y_{gr}ⁱ is the result multiplied by the first multiplier with respect to the i-th class, m_{gr}ⁱ is a mean vector of Y_{gr}ⁱ in the i-th class, m_{gr} is a total mean vector of results multiplied by the first multiplier, T is transpose, cᵢ is an i-th class, G is a total number of blocks placed on the e-th layer in a horizontal direction, R is a total number of blocks placed on the e-th layer in a vertical direction, 1≦g≦G, and 1≦r≦R.

5. The apparatus of claim 4, wherein the transformation matrix calculator calculates the discriminant transformation matrix using the following equation:
$${W}_{gr} = {arg max}_{{W}_{gr}} \frac{\vert {W}_{gr}^{T} {S}_{gr}^{B} {W}_{gr} \vert}{\vert {W}_{gr}^{T} {S}_{gr}^{W} {W}_{gr} \vert} .$$

6. The apparatus of claim 1, further comprising:
a matrix transposing unit transposing the final basis matrix generated by the first through E-th layer basis matrix generators; and
a feature matrix calculator multiplying the zero mean matrix by the result transposed by the matrix transposing unit and outputting the multiplied result as a feature matrix.

7. The apparatus of claim 6, further comprising:
a storage unit storing the feature matrices outputted from the feature matrix calculator with respect to previous images; and
a correlation calculator calculating a final correlation between the feature matrices outputted from the feature matrix calculator with respect to current images and the feature matrices read from the storage unit with respect to the previous images,
wherein the previous images correspond to the images that have been previously inputted, and the current images correspond to the images that are currently inputted.

8. The apparatus of claim 7, wherein the correlation calculator includes:
first through E-th correlation calculators respectively calculating first through E-th correlations between the current images and the previous images; and
a synthesizing unit synthesizing the first through E-th correlations and outputting the synthesized result as the final correlation,
wherein the e-th correlation calculator calculates the e-th correlation between the previous image and the current image with respect to the e-th layer using the following equation:
$${S}_{e} ( a , b ) = {\sum }_{r = 1}^{R} {\sum }_{g = 1}^{G} {W}_{gr} ( \frac{{( {f}_{gr}^{e} )}^{a} \cdot {( {f}_{gr}^{e} )}^{b}}{‖ {( {f}_{gr}^{e} )}^{a} ‖ \cdot ‖ {( {f}_{gr}^{e} )}^{a} ‖} )$$
, where Sₑ(a,b) is the e-th correlation between the previous image a and the current image b with respect to the e-th layer, W_{gr} is the discriminant transformation matrix
$${\sum }_{r = 1}^{R} {\sum }_{g = 1}^{G} {W}_{gr} = 1 ,$$
G is a total number of blocks placed on the e-th layer in a horizontal direction, R is a total number of blocks placed on the e-th layer in a vertical direction, 1≦g≦G, 1≦r≦R, (f_{gr}^{e})^{a} is a feature vector of a block placed at a g-th position in a horizontal direction and at a r-th position in a vertical direction on an e-th layer of an image a and the result of multiplying V_{gr}^{T} and the zero mean vector, V_{gr}^{T} is the result of transposing the result in which the block model is multiplied by the discriminant transformation matrix, (f_{gr}^{e})^{b} is a feature vector of a block placed at a g-th position in a horizontal direction and at a r-th position in a vertical direction on the e-th layer of an image b, the feature matrix is composed of the first through GR feature vectors, and ∥ ∥ is a norm.

9. The apparatus of claim 7, further comprising:
a comparator comparing the final correlation calculated by the correlation calculator with a specified value; and
a correlation determining unit determining a correlation between the previous image and the current image in response to the compared result.

10. A method of processing an image based on layers, the method comprising:
dividing the image into E layers, each layer having at least one block, E being a positive integer equal to or greater than 2; and
generating first through E-th layer basis matrices using the divided image and determining a set of the first through E-th layer basis matrices as a final basis matrix,
wherein the generating of the e-th (1≦e≦E) layer basis matrix includes, with respect to each block included in the e-th layer, generating a block model using a kernel matrix obtained by local feature analysis, multiplying a zero mean matrix generated from the divided image by a result of transposing the block model, calculating a between-class scatter matrix and a within-class scatter matrix by linear discriminant analysis using the multiplied result, calculating a discriminant transformation matrix using the calculated between-class scatter matrix and the calculated within-class scatter matrix, multiplying the discriminant transformation matrix by the block model, outputting the multiplied result as a subbasis matrix, and outputting a set of the subbasis matrices generated in all of the blocks included in the e-th layer as an e-th layer basis matrix, and
wherein a number of blocks differs for each of the layers.

11. The method of claim 10, wherein the generating of the e-th basis
matrix comprises generating first through Q-th (where Q is a total number of blocks included in the e-th layer) subbasis matrices and determining a set of the first through Q-th subbasis matrices as the e-th layer basis matrix, and
wherein the generating of the q-th (1≦q≦Q) subbasis matrix includes:
generating the block model using the kernel matrix;
transposing the block model;
multiplying the zero mean matrix and the transposed block model;
obtaining the between-class scatter matrix and the within-class scatter matrix using the multiplication result;
obtaining the discriminant transformation matrix using the between-class scatter matrix and the within-class scatter matrix; and
multiplying the discriminant transformation matrix by the block model and determining the multiplied result as the q-th subbasis matrix.

12. The method of claim 10, further comprising:
transposing the final basis matrix; and
multiplying the zero mean matrix by the transposed result and determining the multiplied result as a feature matrix.

13. The method of claim 12, further comprising:
obtaining feature matrices with respect to previous images and storing the obtained feature matrices;
obtaining feature matrices with respect to current images; and
obtaining a final correlation between the feature matrices obtained with respect to the current images and the feature matrices obtained with respect to the stored previous images,
wherein the previous images correspond to the images that have been previously inputted, and the current images correspond to the images that have been currently inputted.

14. The method of claim 13, further comprising:
determining whether the final correlation is equal to or greater than a specified value; and
when the final correlation is at least equal to the specified value, recognizing that the previous images and the current images are similar to one another.

15. An image processing apparatus, the apparatus comprising:
an image divider dividing an the into E layers each having at least one block, E being a positive integer at least equal to 2; and
first through E-th layer basis matrix generators respectively generating first through E-th layer basis matrices based on the divided image and outputting a set of the first through E-th layer basis matrices as a final basis matrix,
wherein an e-th layer basis matrix generator, for each block of an e-th layer, generates a block model using a kernel matrix obtained by local feature analysis, multiplies a zero mean matrix based on the divided image by a result of transposing the block model, calculates a between-class scatter matrix and a within-class scatter matrix by linear discriminant analysis based on the multiplied result, calculates a discriminant transformation matrix based on the between-class scatter matrix and the within-class scatter matrix, multiplies the discriminant transformation matrix by the block model, outputs the multiplied result as a subbasis matrix, and outputs a set of subbasis matrices generated in all of the blocks included in the e-th layer as the e-th layer basis matrix,
wherein e is a positive integer between 1 and E, and
wherein a number of blocks differs for each layer.
